(19) United States
(12) Patent Application Publication
(10) Pub. No.: US 2005/0111232 A1
(43) Pub. Date: May 26, 2005

(54) Attached flip-open covers for auxiliary lamps

(76) Inventor: Jonathan D. Olson, Sacramento, CA (US)

Correspondence Address: Jonathan D. Olson, 5013 H Parkway, Sacramento, CA, 95823, US

(21) Appl. No.: 10/794,468

(22) Filed: Mar. 6, 2004

Related U.S. Application Data
(60) Provisional application No. 60/479,269, filed on Jun. 18, 2003.

(51) Int. Cl. F21V 21/084; B60Q 1/00; B60Q 3/00

(52) U.S. Cl. 362/546

(57) ABSTRACT

A shield assembly (44) that easily attaches to an auxiliary light blocking dirt and debris from external sources, and the radiation of light from said lamp. This system comprises a shield (40), and pivot housing assembly (42). A user of the shield assembly (44) can easily install it onto existing auxiliary lights (18) by means of securing the pivot housing assembly (42) to the existing hardware, comprising the boot ring (19) and the boot (20), on said auxiliary light(s). During times that it is undesirable to have said light(s) (18) exposed, the shield(s) (40) is/are kept in place by means of the latch (38) and pin (48). When conditions arise in which one would use said auxiliary light(s) (18), the user releases the latch (38) thereby allowing the spring (50), concealed in the pivot housing (42), to force the shield (40) to the open position and maintain the shield's position there. When it is no longer desirable to have the light (18) exposed, the user can close and secure the shield (40) by rotating the shield (40) in the opposite direction of that which it was opened. One needs only to apply enough force to overcome the spring (50) and secure the latch (38). Thus a considerably improved auxiliary lighting shield is provided that can be opened and closed easily while remaining attached to the auxiliary light saving the user time, and using only one hand.

### CROSS-REFERENCE TO RELATED APPLICATIONS

60/479,269

### FEDERALLY SPONSORED RESEARCH

None.

### SEQUENCE LISTING

None.

### BACKGROUND OF THE INVENTION—FIELD OF THE INVENTION

This invention relates to auxiliary light covers and shields which are used to cover automotive and other types of auxiliary lamps.

### BACKGROUND OF THE INVENTION

The use of additional or auxiliary lighting systems in motor vehicles is well known. Such auxiliary lighting includes what are known as fog lamps, utility lamps, emergency lamps, driving lamps, and off-road lamps. These lamps differ in the intensity and pattern of the light beam produced and are especially tailored to the respective applications.

In many jurisdictions, it is required that auxiliary lighting be shielded while on county, state, or federal roads. Thus, one must keep such light shielded or covered while on said roads. Once off of said roads, one would then remove a shield and enable an auxiliary light. Also, shields are used to protect lamps from damage or allowing debris to come into contact with the lamp's lens while the lights are not in use.

Www.daylighter.com shows covers for auxiliary lighting. One cover is formed from a flexible plastic material and is held in place through the use of latches on each side of the cover. Removal of the shield requires the manipulation of two separate latches. This is a hindrance in that it requires the use of two hands to remove said shield. Furthermore, after removal of the shield, there comes a need to store said shield. This presents the problem that, while removed, the shield may become damaged or lost.

Www.daylighter.com also shows a cover that is made of a pliable material, like canvas, and has an elastic band around the edge of the cover. This band must be stretched out in order to fit over a lamp and subsequently released to keep it in place. This type of cover requires two hands, and can take a considerable amount of time to install. After removal of a shield, there comes a need to store said shield. This again presents a problem that, while removed, the shield may become damaged or lost. Also the repeated stretching and subsequent release of the elastic band breaks down the elastic reducing the useful life of the cover.

Further addressing the problem of removing and attaching these covers: Removal and installation of covers is often difficult do to the location of the light, i.e. on rollbars, on top of the vehicle, etc. In such cases the light operator must manually remove a shield before operating the light. This process takes minutes to accomplish due to the physical location of the lights and the type of shield being used.

### BACKGROUND OF INVENTION—OBJECTS AND ADVANTAGES

Accordingly several objects and advantages of the present invention are:
(1) to provide a shield with no need of storage while not in use.
(2) to provide a shield with a reduced time taken to open and close the cover.
(3) to provide a shield that requires only one hand to open or close.

### SUMMARY

The foregoing objects are achieved in the present invention by means of a system that secures to existing auxiliary lighting systems, and with the release of a latch automatically moves a shield from a closed to open position, and keeps the shield open, by means of a spring, until the operator rotates the shield to the closed position.

In view of the foregoing, it is therefore an object of the present invention to eliminate the need for storage of a shield.

Another object of the present invention is to provide a means of moving the shield from a closed to open position without manually removing said shield. The present invention also provides a means of opening the shield in seconds by releasing a latching mechanism.

A further object of the present invention is to provide a simple means of closing and securing the shield saving time in both processes over previous arts. In addition, both opening and closing processes are accomplished with the use of a single hand.

### DRAWINGS—FIGURES

FIG. 1 Illustrates auxiliary lighting in the form of off-road lamps attached to a vehicle.

FIG. 2 Illustrates an exploded view of an auxiliary lamp.

FIG. 3 Illustrates an exploded view of the preferred embodiment of the shield assembly in accordance with the present invention.

FIG. 4 Illustrates the shield assembly attached to the boot ring and in the open position.

FIG. 5 Illustrates a perspective left-side cut-away view of the shield assembly attached to the lamp and in the closed position detailing the latching mechanism.

### REFERENCE NUMERALS

18. Auxiliary lamp/light
19. Boot ring
20. Boot
21. Boot ring bolt
28. Pivot arm A
30. Pivot arm B
32. Spacing block
34. Peripheral light/debris shield
36. Frontal light/debris shield
38. Flexible latch
40. Shield
42. Pivot housing assembly
44. Shield assembly
46. Upper pivot housing
48. Shield attachment pin
50. Helical torsion spring
51. Lower pivot housing
52. Spacer/spring tension controller
54. Screw
56. Screw

### DETAILED DESCRIPTIONS

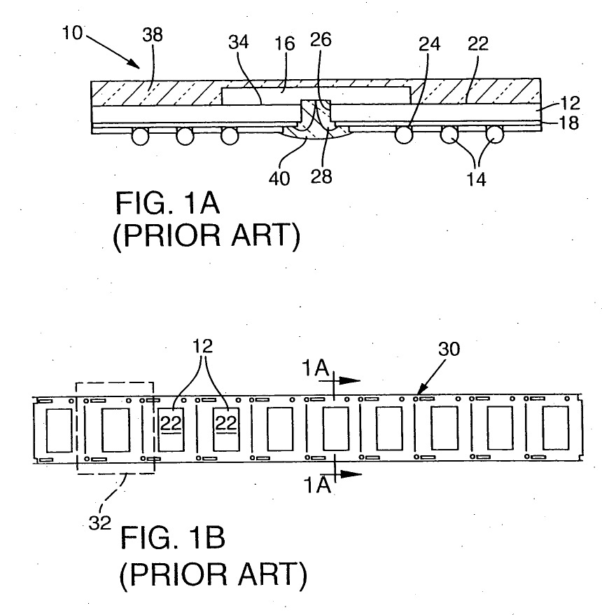

FIG. 1 is a perspective view taken from a vehicles front passenger side showing auxiliary lamps 18 mounted to a rollbar in the standard fashion, above the trucks cab.

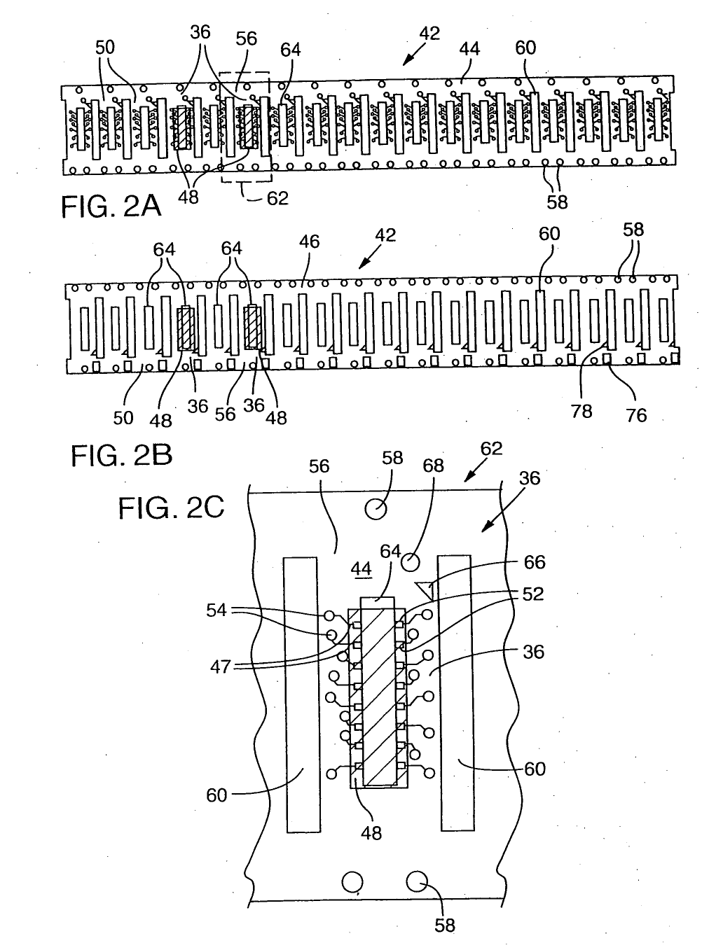

FIG. 2 is an exploded view of the auxiliary lamp 18 detailing the boot ring 19, boot 20, and boot ring bolt 21.

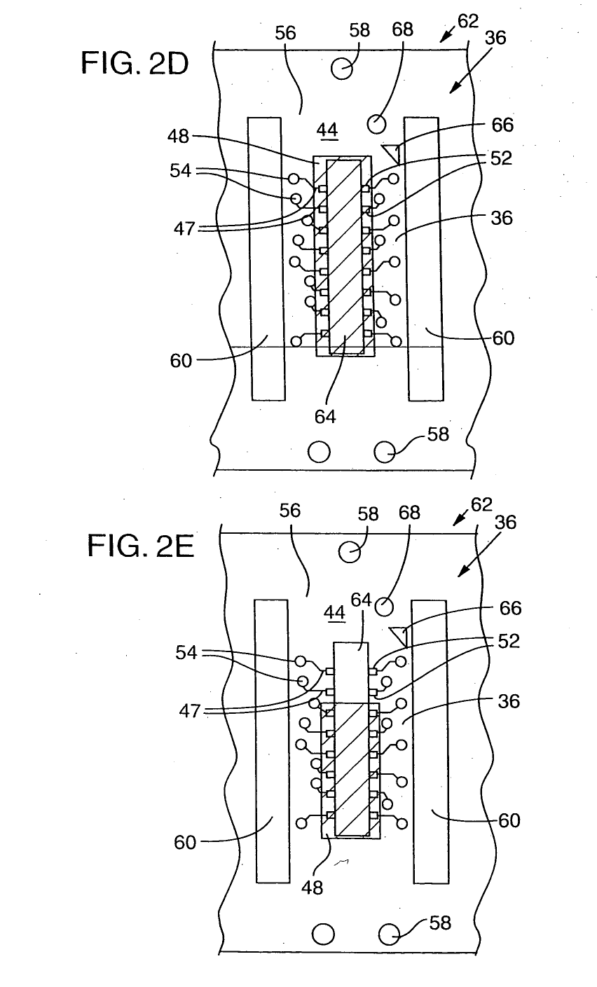

FIG. 3 is an exploded view of a shield assembly 44. The shield assembly 44 comprises a shield 40, and a pivot housing assembly 42.

The shield 40, comprised of plastic material, is formed from the following pieces: arm 28, arm 30, spacing block 32, peripheral light/debris shield 34, front light shield 36, latch 38 (not shown). These pieces may be glued, screwed, thermally bonded, or a combination of the aforementioned methods, together to form shield 40. Alternately, shield 40 may be molded, cast, carved, or formed as a single piece from any suitable material. This is not intended to limit the scope of material or methods of making the said shield assembly 44.

The pivot housing assembly 42 comprises an upper pivot housing 46, lower pivot housing 51, shield attachment pin 48, helical torsion spring 50, screws 54 and 56, and a spacer/spring tension controller 52. The helical torsion spring 50 is fitted around the shield pin attachment 48, with one end of the spring 50 fitted through the pin 48 to keep it in place. The pin 48 is fitted through one hole in the pivot housing 46 by first inserting one end of the pin 48, from the bottom of the pivot housing through said hole from the inside, then by rotating the pin 48 upwards and sliding it through the second hole. The opposite end of the spring 50, which is strait, is fitted into the spacer/tension controller 52. The spacer 52 fits under the pin 48 and in-between the upper housing 46 and lower housing 51.

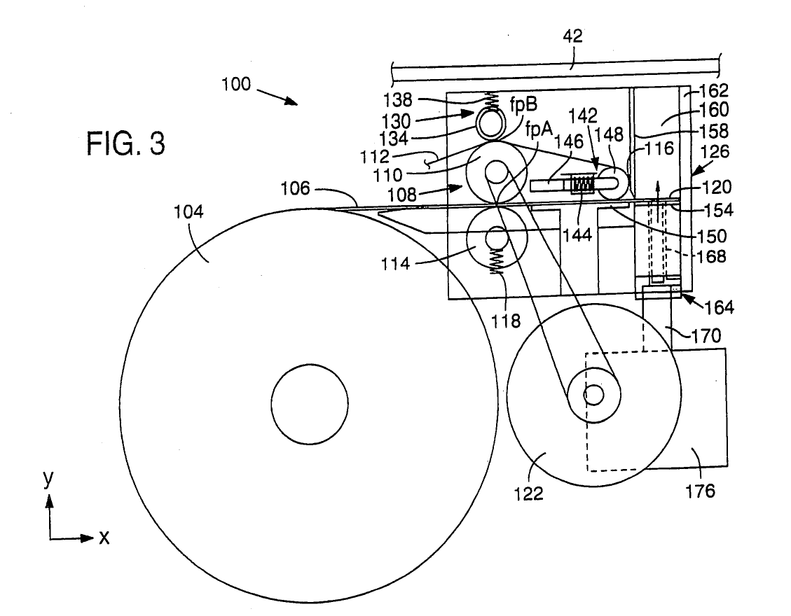

FIG. 4 is a left perspective view of the shield assembly 44 attached to the boot ring 19, with the shield in the open position. The latch 38 is shown and also its latching object, the bolt 21. The lower pivot housing 51 is secured between the boot ring 19 above and the boot 20 (not shown) below. The bolt 21 draws the ring 19 tight to the boot 20 locking the lower pivot housing 51 securely in place.

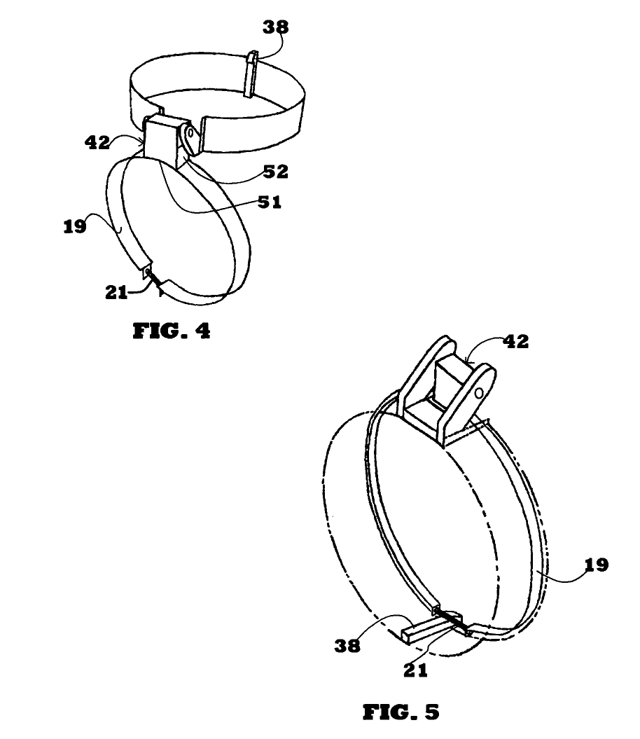

FIG. 5 is a cut-away perspective left-side view of the shield 40, in the closed position, showing the latch 38 hooking its latching object, the bolt 21. When one rotates the shield 40 about the pin 48 to the closed position, the torsion spring 50 opposes the closing force. While closing the shield 40, the upper and lower pivot housings, 46 and 51 respectively, remain in place, with the pin 48 and spring 50 (not shown) rotating inside of the pivot housing assembly 42. The latch 38 slides under the bolt 21 and is secure until such time that the operator releases the latch 38 by applying downward pressure to the latch 38. When the latch 38 is moved downward enough so that the upper portion of the latch 38 is able to slide beneath the bolt 21, then the spring 50 forces the shield 40 to the open position depicted in FIG. 4.

### OPERATION

In operation one uses this shield 44 to cover auxiliary lights when desired. It serves the purpose of blocking light from escaping and from allowing debris to come into contact with the lamp's lens rendering the lamp unuseable or damaging the lamp. The user can, when desired, open the shield 40 with great ease through applying downward pressure to the latch 38 so that the spring 50 can force the shield 40 to the open position allowing light to radiate from the lamp 18. There are three areas of improvement over previous art:
(1) The present invention eliminates the need for storage when the shield 40 is open.
(2) The present invention provides a means of quickly opening, with a single hand, the shield 40 without manually removing the shield 40.
(3) The present invention provides a means of easily closing the shield 40 with one hand reducing time in this process from previous covers.

1. The improvements to auxiliary lighting covers comprising:
Shield:
While in closed position, covering individual lights to prevent dirt and debris from adhering to light while the lamp is not in use. This feature also prevents the radiation of light from the lighting source.
Flexible Latch:
The method of keeping the shield in the closed position for the aforementioned purpose.
Shield Attachment Pin and Helical Torsion Spring:
Means of returning the shield to an open position when the latch is released.
Pivot Housing with Ring Attachment:
Conceals the torsion spring and the shield attachment pin, and attaches the shield to the auxiliary lighting device.

2. The improvements in the need for storage over previous auxiliary lighting covers.
This new invention removes the need of storage, while the cover is in the open position.

3. The improvements in the opening and closing process beyond previous arts.
This new art enhances the opening process by reducing the time to open and close the shield before light use. Furthermore one can perform both the opening and closing processes with one hand.
